(19) United States
(12) Patent Application Publication
(10) Pub. No.: US 2020/0192358 A1
(43) Pub. Date: Jun. 18, 2020

(54) METHOD, APPARATUS, SYSTEM AND STORAGE MEDIUM FOR AUTHORIZING AUTONOMOUS DRIVING FUNCTION

(71) Applicant: BEIJING BAIDU NETCOM SCIENCE AND TECHNOLOGY CO., LTD, Beijing (CN)

(72) Inventor: Ning Yu, Beijing (CN)

(21) Appl. No.: 16/710,428

(22) Filed: Dec. 11, 2019

(30) Foreign Application Priority Data
Dec. 12, 2018 (CN) 201811519391.2

(51) Int. Cl. G05D 1/00; H04L 29/06; G06F 16/23; B60R 25/30; B60R 25/24

(52) U.S. Cl. CPC G05D 1/0061; H04L 63/08; G06F 16/2379; G05D 2201/0213; B60R 25/241; B60R 2325/40; B60R 25/30

(57) ABSTRACT

A method, an apparatus, a system and a storage medium for authorizing an autonomous driving function are proposed. The method comprises: sending, by a control system in an autonomous vehicle, an authorization request to a cloud server, when the autonomous driving function needs to be activated; and activating, by the control system, the autonomous driving function, in response to receiving authorization approval instruction information returned by the cloud server after the cloud server verifies authorization for the autonomous vehicle and approves authorization. The technical solution may improve safety of the vehicle and the user.

### CROSS REFERENCE TO RELATED APPLICATIONS

The present application claims the priority of Chinese Patent Application No. 201811519391.2, filed on Dec. 12, 2018, with the title of “Method, apparatus, system and storage medium for authorizing autonomous driving function”. The disclosure of the above applications is incorporated herein by reference in its entirety.

### FIELD

The present disclosure relates to computer application technologies, and particularly to a method, an apparatus, a system and a storage medium for authorizing an autonomous driving function.

### BACKGROUND

At present, development of autonomous vehicles is still in a relatively primary stage, and autonomous vehicles have a limited capability and can only drive autonomously in a specific scenario.

Then, after the autonomous vehicle is delivered to a user, if the user randomly activates the autonomous driving function not in an authorized and correct manner agreed between the manufacturer and the user, this is very likely to cause an accident, thereby affecting the safety of the vehicle and the user.

### SUMMARY

In view of the above, the present disclosure provides a method, an apparatus, a system and a storage medium for authorizing an autonomous driving function.

Specific technical solutions are as follows:

According to an embodiment, a method for authorizing an autonomous driving function is proposed, and the method may include:

sending, by a control system in an autonomous vehicle, an authorization request to a cloud server, when the autonomous driving function needs to be activated; and

activating, by the control system, the autonomous driving function, in response to receiving authorization approval instruction information returned by the cloud server after the cloud server verifies authorization for the autonomous vehicle and approves authorization.

According to an embodiment, the method may further include: forbidding activation of the autonomous driving function, in response to receiving authorization disapproval instruction information returned by the cloud server after the cloud server verifies authorization for the autonomous vehicle and disapproves authorization.

According to an embodiment, the method may further include: obtaining information regarding a reason for authorization disapproval included in the authorization disapproval instruction information.

According to an embodiment, the control system may communicate with the cloud server in a Secure Sockets Layer two-way authentication manner.

According to an embodiment, a method for authorizing an autonomous driving function is proposed, and the method may include:

obtaining, by a cloud server, an authorization request sent from a control system in an autonomous vehicle, wherein the authorization request is sent when the autonomous driving function of the autonomous vehicle needs to be activated; and

verifying, by the cloud server, authorization for the autonomous vehicle, and in response to approving authorization, returning authorization approval instruction information to the control system, so that the control system activates the autonomous driving function.

According to an embodiment, the method may further include: in response to disapproving authorization, returning authorization disapproval instruction information to the control system, so that the control system forbids activation of the autonomous driving function.

According to an embodiment, the authorization disapproval instruction information may include information regarding a reason for authorization disapproval.

According to an embodiment, the cloud server may communicate with the control system in a Secure Sockets Layer two-way authentication manner.

According to an embodiment, verifying by the cloud server authorization for the autonomous vehicle may include:

obtaining N pieces of predetermined information about the autonomous vehicle, N being a positive integer;

determining whether the autonomous vehicle meets authorization requirement according to the predetermined information,

approving authorization if the autonomous vehicle meets the authorization requirement, and

disapproving authorization if the autonomous vehicle does not meet the authorization requirement.

According to an embodiment, an apparatus for authorizing an autonomous driving function is proposed, and the apparatus may include:

a sending unit for sending an authorization request to a cloud server when the autonomous driving function of an autonomous vehicle needs to be activated; and

a control unit for activating the autonomous driving function in response to receiving authorization approval instruction information returned by the cloud server after the cloud server verifies authorization for the autonomous vehicle and approves authorization.

According to an embodiment, the control unit further forbids activation of the autonomous driving function in response to receiving authorization disapproval instruction information returned by the cloud server after the cloud server verifies authorization for the autonomous vehicle and disapproves authorization.

According to an embodiment, the control unit further obtains information regarding a reason for authorization disapproval included in the authorization disapproval instruction information.

According to an embodiment, the sending unit and the control unit communicate with the cloud server in a Secure Sockets Layer two-way authentication manner.

According to an embodiment, an apparatus for authorizing an autonomous driving function is proposed, the apparatus may include:

an obtaining unit for obtaining an authorization request sent from a control system in an autonomous vehicle, wherein the authorization request is sent when the autonomous driving function of the autonomous vehicle needs to be activated;

an authorizing unit for verifying authorization for the autonomous vehicle, and in response to approving authorization, returning authorization approval instruction information to the control system, so that the control system activates the autonomous driving function.

According to an embodiment, in response to disapproving authorization, the authorizing unit returns authorization disapproval instruction information to the control system, so that the control system forbids activation of the autonomous driving function.

According to an embodiment, the authorization disapproval instruction information includes information regarding a reason for authorization disapproval.

According to an embodiment, the obtaining unit and the authorizing unit communicate with the control system in a Secure Sockets Layer two-way authentication manner.

According to an embodiment, the authorizing unit obtains N pieces of predetermined information about the autonomous vehicle, N being a positive integer, and then determines whether the autonomous vehicle meets authorization requirement according to the predetermined information, and approves authorization if the autonomous vehicle meets the authorization requirement; and disapproves authorization if the autonomous vehicle does not meet the authorization requirement.

According to an embodiment, a system for authorizing an automatic driving function may include the above two types of apparatuses for authorizing the automatic driving function.

According to an embodiment, a computer device is proposed, and the computer device may include a memory, a processor and a computer program which is stored on the memory and runs on the processor, the processor, upon executing the program, implementing the above-mentioned methods.

According to an embodiment, a computer-readable storage medium is proposed, and on the computer-readable storage medium a computer program is stored, the program, when executed by the processor, implementing the aforesaid methods.

As can be seen from the above description, according to the technical solutions of the present disclosure, when the autonomous driving function needs to be activated, the control system in the autonomous vehicle may send an authorization request to the cloud server, and the autonomous driving function can be activated only in response to receiving authorization approval instruction information returned by the cloud server after the cloud server verifies authorization for the autonomous vehicle and approves authorization, thereby avoiding the user's unauthorized and random start of the autonomous driving function, reducing the possibility of occurrence of an autonomous driving accident, and thereby improving the safety of the vehicle and the user.

### BRIEF DESCRIPTION OF THE DRAWINGS

FIG. 1 is a flow chart of a method for authorizing an autonomous driving function according to an embodiment of the present disclosure.

FIG. 2 is a flow chart of a method for authorizing an autonomous driving function according to an embodiment of the present disclosure.

FIG. 3 is a flow chart of a method for authorizing an autonomous driving function according to an embodiment of the present disclosure.

FIG. 4 is a structural schematic diagram of components of an apparatus for authorizing an autonomous driving function according to an embodiment of the present disclosure.

FIG. 5 is a structural schematic diagram of components of an apparatus for authorizing an autonomous driving function according to an embodiment of the present disclosure.

FIG. 6 illustrates a block diagram of an example computer system/server 12 adapted to implement an implementation mode of the present disclosure.

### DETAILED DESCRIPTION OF EMBODIMENTS

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

It should be appreciated that the term “and/or” used in the text is only an association relationship depicting associated objects and indicates that three relations might exist, for example, A and/or B may represents three cases, namely, A exists individually, both A and B coexist, and B exists individually. In addition, the symbol “/” in the text generally indicates associated objects before and after the symbol are in an “or” relationship.

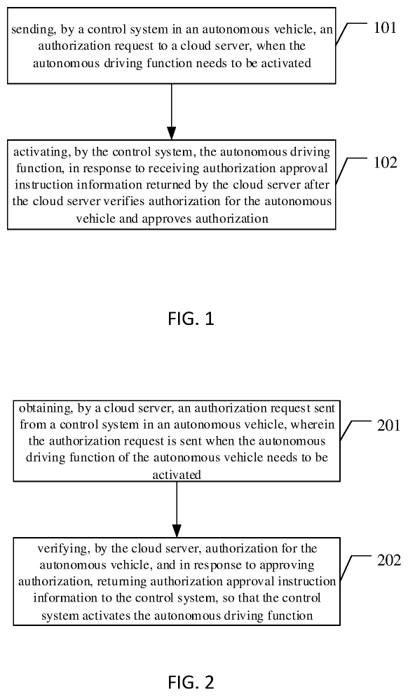

FIG. 1 is a flow chart of a method for authorizing an autonomous driving function according to an embodiment of the present disclosure. As shown in FIG. 1, the embodiment comprises the following specific implementation mode.

At 101, sending, by a control system in an autonomous vehicle, an authorization request to a cloud server, when the autonomous driving function needs to be activated.

At 102, activating, by the control system, the autonomous driving function, in response to receiving authorization approval instruction information returned by the cloud server after the cloud server verifies authorization for the autonomous vehicle and approves authorization.

As stated above, after the autonomous vehicle is delivered to a user, if the user randomly activates the autonomous driving function not in a correct manner agreed between the manufacturer and the user, it is very likely to cause an accident, thereby affecting the safety of the vehicle and the user.

In order to improve the safety of the vehicle and the user and meanwhile avoid unnecessary legal disputes, it is necessary to authorize before the user activates the autonomous driving function. Only when the authorization succeeds can the autonomous driving function be started normally.

To this end, in an embodiment, each time that the autonomous driving function needs to be activated, the control system in the autonomous vehicle needs to send an authorization request to the cloud server, so that the cloud server verifies whether to approve the authorization for the autonomous vehicle.

A need to activate the autonomous driving function might mean that the user request to switch from a manual driving mode to an autonomous driving mode, or may mean that the user directly requests to start the autonomous driving mode.

If the authorization approval instruction information is returned by the cloud server after the cloud server verifies authorization for the autonomous vehicle and approves authorization, this means that authorization is approved, the autonomous driving function is allowed to be activated, and accordingly the control system may activate the autonomous driving function.

In contrast, authorization disapproval instruction information is returned by the cloud server after the cloud server verifies authorization for the autonomous vehicle and disapproves authorization, this means that authorization is disapproved, and then the autonomous driving function may be forbidden. In general, although the activation of the autonomous driving function is forbidden, the manual driving function is still allowed.

In addition, the authorization disapproval instruction information may also include information regarding a reason for authorization disapproval, so that the control system may know the specific reason for the authorization disapproval.

Furthermore, after obtaining the reason for authorization disapproval, the control system may also notify occupants of the vehicle, such as the driver, of the reason in a certain manner. The certain manner may be a voice broadcast manner or the like. Assuming that the driver requests to switch from the manual driving mode to the autonomous driving mode, after the reason for the authorization disapproval is known and if the reason is a cause that can be overcome, the switching request may be initiated again after the cause is overcome, thereby ensuring the successful completion of the switching.

The above description is mainly presented from the side of the autonomous vehicle, and the solution of the present disclosure will be further described below from the side of the cloud server.

FIG. 2 is a flow chart of a method for authorizing an autonomous driving function according to an embodiment of the present disclosure. As shown in FIG. 2, the embodiment comprises the following specific implementation mode.

At 201, obtaining, by a cloud server, an authorization request sent from a control system in an autonomous vehicle, the authorization request is sent when the autonomous driving function of the autonomous vehicle needs to be activated.

At 202, verifying, by the cloud server, authorization for the autonomous vehicle, and in response to approving authorization, returning authorization approval instruction information to the control system, so that the control system activates the autonomous driving function.

After obtaining the authorization request sent from the control system in the autonomous vehicle, the cloud server may determine the autonomous vehicle that needs to be verified for authorization, according to information included in the authorization request such as identification of the autonomous vehicle, and then verify whether to authorize the determined autonomous vehicle in a predetermined manner, and return the authorization result to the control system.

The authorization result may include the authorization approval instruction information returned when the authorization is approved, and the authorization disapproval instruction information returned when the authorization is disapproved. If the authorization approval instruction information is received, the control system may activate the autonomous driving function, and if the authorization disapproval instruction information is received, the control system may forbid activation of the autonomous driving function.

The authorization disapproval instruction information may also include the information regarding a reason for authorization disapproval so that the control system may acquire the specific reason about authorization disapproval.

Upon verifying whether to authorize the autonomous vehicle, the cloud server may first obtain N pieces of predetermined information about the autonomous vehicle, wherein N is a positive integer, and specific information needs to be obtained according to actual needs, and then determine whether the autonomous vehicle meets authorization requirement according to the obtained predetermined information, and approve the authorization if the autonomous vehicle meets the authorization requirement, or disapprove the authorization if the autonomous vehicle does not meet the authorization requirement.

The cloud server may maintain a vehicle information record table for each autonomous vehicle, and the vehicle information record table may record the following information of the autonomous vehicle: whether the autonomous vehicle is already kept in file, whether there is a violation record in the autonomous driving process, a range of areas allowed to travel, and so on. The vehicle information record table may be manually set and may be updated at any time according to actual needs.

In addition, during the driving process, the autonomous vehicle will upload various data reflecting the state of the vehicle to a database in the background in real time, and the data may include vehicle speed, acceleration, vehicle location, throttle, gear position and so on.

When the cloud server verifies whether to authorize the autonomous vehicle, the cloud server may obtain desired information from the vehicle information record table and the database, and may determine whether the autonomous vehicle meets authorization requirements according to the obtained information, and approve the authorization if the autonomous vehicle meets the authorization requirement, or disapprove the authorization if autonomous vehicle does not meet the authorization requirements.

For example, the information obtained by the cloud server may include whether there is a violation record during the autonomous driving process, a range of areas allowed to travel, a vehicle location and a vehicle speed. If there is a violation record during the autonomous driving process, it may be determined that the autonomous vehicle has a safety risk, thereby determining that the autonomous vehicle does not meet the authorization requirement and disapproving the authorization. Optionally, if the obtained vehicle speed is 100 km/h and the vehicle's safe speed is 80 km/h, the vehicle may not be authorized. Optionally, if it is determined from the obtained vehicle location that the vehicle is currently outside the range of the allowed driving areas, the vehicle may not be authorized. If the above pieces of information all meet the authorization requirements, the vehicle may be authorized.

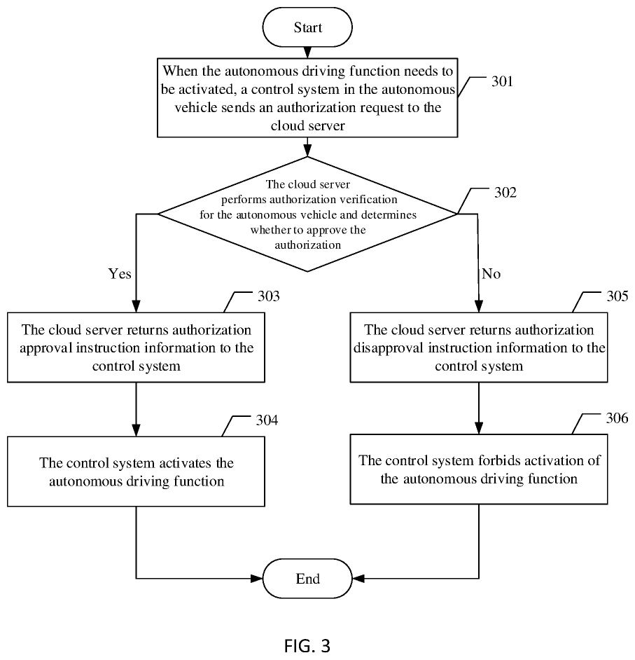

Based on the above description, FIG. 3 is a flow chart of a method for authorizing an autonomous driving function according to an embodiment of the present disclosure. As shown in FIG. 3, the embodiment comprises the following specific implementation mode.

At 301, when the autonomous driving function needs to be activated, the control system in the autonomous vehicle sends an authorization request to the cloud server.

A need to activate the autonomous driving function might mean that the user request to switch from a manual driving mode to an autonomous driving mode, or may mean that the user directly requests to start the autonomous driving mode.

At 302, the cloud server performs authorization verification for the autonomous vehicle, determines whether to approve the authorization, and performs 303 if yes, or performs 305 if no.

Upon performing authorization verification for the autonomous vehicle, the cloud server may first obtain N pieces of predetermined information about the autonomous vehicle, wherein N is a positive integer, and specific information needs to be obtained according to actual needs, and then determine whether the autonomous vehicle meets authorization requirement according to the obtained predetermined information, and approve the authorization if yes, or disapprove the authorization if no.

At 303, the cloud server returns authorization approval instruction information to the control system.

If the authorization is approved, the cloud server may return the authorization approval instruction information to the control system.

At 304, the control system activates the autonomous driving function and ends the process.

If the authorization approval instruction information returned by the cloud server after the cloud server verifies authorization for the autonomous vehicle and approves authorization is received, this means that authorization is approved, the autonomous driving function is allowed to be activated, and accordingly the control system may activate the autonomous driving function.

At 305, the cloud server returns authorization disapproval instruction information to the control system.

If the authorization is disapproved, the cloud server may return the authorization disapproval instruction information to the control system.

The authorization disapproval instruction information may also include information regarding a reason for authorization disapproval so that the control system may acquire the specific reason about authorization failure.

At 306, the control system forbids activation of the autonomous driving function and ends the process.

If authorization disapproval instruction information returned by the cloud server after the cloud server verifies authorization for the autonomous vehicle and disapprove authorization is received, this means that authorization is disapproved, and then activation of the autonomous driving function may be forbidden.

The control system may communicate with the cloud server in a Secure Sockets Layer (SSL) two-way authentication manner to ensure the security of incoming and outgoing information. The traditional one-way authentication manner means that only one object verifies the validity of the certificate of an opposite end, and usually the client verifies the validity of the server. In contrast, the two-way authentication requires mutual verification: the server needs to verify the client, and the client also needs to verify the client, and therefore provides higher safety.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, embodiments are respectively described with different emphasis being placed, and reference may be made to related depictions in other embodiments for portions not detailed in a certain embodiment.

In summary, by the technical solutions of the embodiments of the method of the present disclosure, when the autonomous driving function needs to be activated, the control system in the autonomous vehicle may request authorization from the cloud server, and the autonomous driving function can be activated only upon reception of the authorization approval instruction information returned by the cloud server after the cloud server verifies the authorization for the autonomous vehicle and approves authorization, thereby avoiding the user's unauthorized and random start of the autonomous driving function, reducing the possibility of occurrence of an autonomous driving accident, and thereby improving the safety of the vehicle and the user.

The above introduces embodiments of the method. The solution of the present disclosure will be further described through embodiments of an apparatus.

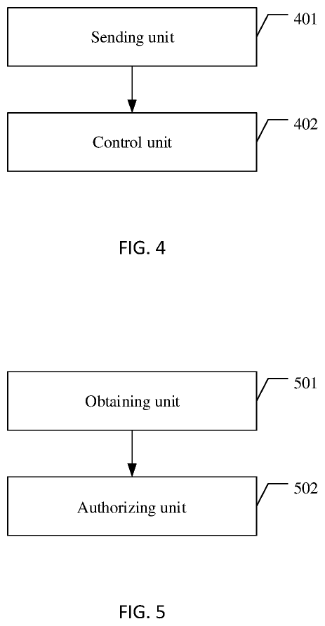

FIG. 4 is a structural schematic diagram of components of an apparatus for authorizing an autonomous driving function according to an embodiment of the present disclosure. As shown in FIG. 4, the apparatus includes a sending unit 401 and a control unit 402.

The sending unit 401 is configured to send an authorization request to a cloud server when the autonomous driving function of the autonomous vehicle needs to be activated.

The control unit 402 is configured to activate the autonomous driving function in response to receiving authorization approval instruction information returned by the cloud server after the cloud server verifies authorization for the autonomous vehicle and approve authorization.

Each time that the autonomous driving function needs to be activated, the sending unit 401 needs to send an authorization request to the cloud server, so that the cloud server verifies whether to authorize the autonomous vehicle.

If authorization approval instruction information returned by the cloud server after the cloud server verifies authorization for the autonomous vehicle and approves authorization is received, it means that authorization is approved, the autonomous driving function is allowed to be activated, and accordingly the control unit 402 may activate the autonomous driving function.

In contrast, if authorization disapproval instruction information returned by the cloud server after the cloud server verifies the authorization for the autonomous vehicle and disapproves authorization is received, it means that authorization is disapproved, and then the control unit 402 may forbid activation of the autonomous driving function. In general, although the activation of the autonomous driving function is forbidden, the manual driving function is still allowed.

In addition, the authorization disapproval instruction information may also include information regarding a reason for authorization disapproval, so that the control unit 402 may know the specific reason for the authorization disapproval.

Furthermore, after obtaining the reason for the authorization disapproval, the control unit 402 may also notify occupants of the vehicle such as the driver of the reason in a certain manner. The certain manner may be a voice broadcast manner or the like. Assuming that the driver requests to switch from the manual driving mode to the autonomous driving mode, after the reason for the authorization disapproval is known and if the reason is a cause that can be overcome, the switching request may be initiated again after the cause is overcome, thereby ensuring the successful completion of the switching.

The sending unit 401 and the control unit 402 communicate with the cloud server in an SSL two-way authentication manner to ensure the security of incoming and outgoing information.

FIG. 5 is a structural schematic diagram of components of an apparatus for authorizing an autonomous driving function according to an embodiment of the present disclosure. As shown in FIG. 5, the apparatus includes an obtaining unit 501 and an authorizing unit 502.

The obtaining unit 501 is configured to obtain an authorization request sent from the control system in an autonomous vehicle, the authorization request being sent when the autonomous driving function of the autonomous vehicle needs to be activated.

The authorizing unit 502 is configured to verify authorization for the autonomous vehicle, and in response to approving authorization, return authorization approval instruction information to the control system, so that the control system activates the autonomous driving function.

After the obtaining unit 501 obtains the authorization request sent from the control system in the autonomous vehicle, the authorizing unit 502 may determine the autonomous vehicle that needs to be verified for authorization, according to information included in the authorization request such as identification of the autonomous vehicle, and then verify whether to authorize the determined autonomous vehicle in a predetermined manner, and return the authorization result to the control system.

The authorization result may include the authorization approval instruction information returned when the authorization is approved, and the authorization disapproval instruction information returned when the authorization is disapproved. If the authorization approval instruction information is received, the control system may activate the autonomous driving function, and if the authorization disapproval instruction information is received, the control system may forbid activation of the autonomous driving function.

The authorization disapproval instruction information may also include the information regarding a reason for authorization disapproval, so that the control system may acquire the specific reason about authorization disapproval.

Upon verifying whether to authorize the autonomous vehicle, the authorizing unit 502 may first obtain N pieces of predetermined information about the autonomous vehicle, wherein N is a positive integer, and specific information needs to be obtained according to actual needs, and then determine whether the autonomous vehicle meets authorization requirement according to the obtained predetermined information, and approve the authorization if the autonomous vehicle meets the authorization requirement, or disapprove the authorization if the autonomous vehicle does not meet the authorization requirement.

The obtaining unit 501 and the authorizing unit 502 communicate with the control system in an SSL two-way authentication manner to ensure the security of incoming and outgoing information.

The present disclosure also discloses a system for authorizing an autonomous driving function, comprising the apparatus for authorizing the autonomous driving function shown in FIG. 4 and the apparatus for authorizing the autonomous driving function shown in FIG. 5.

Reference may be made to relevant depictions in the above method embodiments for specific workflows of the above apparatus and system embodiments, which will not be detailed any more here.

To sum up, it is possible to, with the solutions of the apparatus and system embodiments of the present disclosure, avoid the user's unauthorized and random start of the autonomous driving function, reduce the possibility of occurrence of an autonomous driving accident, and thereby improve the safety of the vehicle and the user.

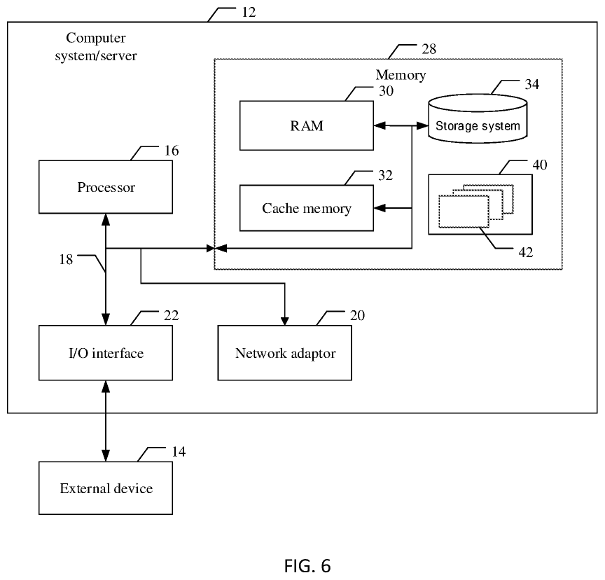

FIG. 6 illustrates a block diagram of an example computer system/server 12 adapted to implement an implementation mode of the present disclosure. The computer system/server 12 shown in FIG. 6 is only an example and should not bring about any limitation to the function and scope of use of the embodiments of the present disclosure.

As shown in FIG. 6, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown in FIG. 6 and typically called a “hard drive”). Although not shown in FIG. 6, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 6, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1 or FIG. 2.

Reference may be made to related depictions in the above embodiments for specific implementations, which will not be detailed any more.

The present disclosure meanwhile provides a computer-readable storage medium on which a computer program is stored, the program, when executed by the processor, implementing the method stated in the embodiment shown in FIG. 1 or FIG. 2.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A computer device for a control system in an autonomous vehicle, comprising a memory, a processor and a computer program which is stored on the memory and runs on the processor, wherein the processor, upon executing the program, implements a method for authorizing an autonomous driving function, wherein the method comprises:
sending, by the control system in the autonomous vehicle, an authorization request to a cloud server, when the autonomous driving function needs to be activated; and
activating, by the control system, the autonomous driving function, in response to receiving authorization approval instruction information returned by the cloud server after the cloud server verifies authorization for the autonomous vehicle and approves authorization.

2. The computer device according to claim 1, wherein the method further comprises:
forbidding activation of the autonomous driving function, in response to receiving authorization disapproval instruction information returned by the cloud server after the cloud server verifies authorization for the autonomous vehicle and disapproves authorization.

3. The computer device according to claim 2, wherein the method further comprises:
obtaining information regarding a reason for authorization disapproval included in the authorization disapproval instruction information.

4. The computer device according to claim 1, wherein the control system communicates with the cloud server in a Secure Sockets Layer two-way authentication manner.

5. The computer device according to claim 1, wherein the autonomous driving function needs to be activated comprises: a user requesting to switch from a manual driving mode to an autonomous driving mode, or the user directly requesting to start the autonomous driving mode.

6. A computer device for a cloud server, comprising a memory, a processor and a computer program which is stored on the memory and runs on the processor, wherein the processor, upon executing the program, implements a method for authorizing an autonomous driving function, wherein the method comprises:
obtaining, by the cloud server, an authorization request sent from a control system in an autonomous vehicle, wherein the authorization request is sent when the autonomous driving function of the autonomous vehicle needs to be activated; and
verifying, by the cloud server, authorization for the autonomous vehicle, and in response to approving authorization, returning authorization approval instruction information to the control system, so that the control system activates the autonomous driving function.

7. The computer device according to claim 6, wherein the method further comprises:
in response to disapproving authorization, returning authorization disapproval instruction information to the control system, so that the control system forbids activation of the autonomous driving function.

8. The computer device according to claim 7, wherein the authorization disapproval instruction information includes information regarding a reason for authorization disapproval.

9. The computer device according to claim 6, wherein the cloud server communicates with the control system in a Secure Sockets Layer two-way authentication manner.

10. The computer device according to claim 6, wherein verifying by the cloud server the authorization for the autonomous vehicle comprises:
obtaining N pieces of predetermined information about the autonomous vehicle, N being a positive integer;
determining whether the autonomous vehicle meets authorization requirement according to the predetermined information,
approving authorization if the autonomous vehicle meets the authorization requirement, and
disapproving authorization if the autonomous vehicle does not meet the authorization requirement.

11. The computer device according to claim 10, wherein the predetermined information about the autonomous vehicle comprises: information from a vehicle information record table for the autonomous vehicle, and information from a database storing data reflecting the state of the autonomous vehicle uploaded by the autonomous vehicle in real time during driving process.

12. A system for authorizing an automatic driving function, comprising:
a first computer device for a control system in an autonomous vehicle, comprising a first memory, a first processor and a first computer program which is stored on the first memory and runs on the first processor, wherein the first processor, upon executing the first program, implements a first method for authorizing an autonomous driving function, wherein the first method comprises:
sending, by the control system in the autonomous vehicle, an authorization request to a cloud server, when the autonomous driving function needs to be activated; and
activating, by the control system, the autonomous driving function, in response to receiving authorization approval instruction information returned by the cloud server after the cloud server verifies authorization for the autonomous vehicle and approves authorization; and
a second computer device for the cloud server, comprising a second memory, a second processor and a second computer program which is stored on the second memory and runs on the second processor, wherein the second processor, upon executing the second program, implements a second method for authorizing the autonomous driving function, wherein the second method comprises:
obtaining, by the cloud server, the authorization request sent from the control system in the autonomous vehicle, wherein the authorization request is sent when the autonomous driving function of the autonomous vehicle needs to be activated; and
verifying, by the cloud server, authorization for the autonomous vehicle, and in response to approving authorization, returning the authorization approval instruction information to the control system, so that the control system activates the autonomous driving function.

13. The system according to claim 12, wherein the first method further comprises:
forbidding activation of the autonomous driving function, in response to receiving authorization disapproval instruction information returned by the cloud server after the cloud server verifies authorization for the autonomous vehicle and disapproves authorization.

14. The system according to claim 13, wherein the first method further comprises:
obtaining information regarding a reason for authorization disapproval included in the authorization disapproval instruction information.

15. The system according to claim 12, wherein the control system communicates with the cloud server in a Secure Sockets Layer two-way authentication manner.

16. The system according to claim 12, wherein the autonomous driving function needs to be activated comprises: a user requesting to switch from a manual driving mode to an autonomous driving mode, or the user directly requesting to start the autonomous driving mode.

17. The system according to claim 12, wherein the second method further comprises:
in response to disapproving authorization, returning authorization disapproval instruction information to the control system, so that the control system forbids activation of the autonomous driving function.

18. The system according to claim 17, wherein the authorization disapproval instruction information includes information regarding a reason for authorization disapproval.

19. The system according to claim 12, wherein verifying by the cloud server the authorization for the autonomous vehicle comprises:
obtaining N pieces of predetermined information about the autonomous vehicle, N being a positive integer;
determining whether the autonomous vehicle meets authorization requirement according to the predetermined information,
approving authorization if the autonomous vehicle meets the authorization requirement, and
disapproving authorization if the autonomous vehicle does not meet the authorization requirement.

20. The system according to claim 19, wherein the predetermined information about the autonomous vehicle comprises: information from a vehicle information record table for the autonomous vehicle, and information from a database storing data reflecting the state of the autonomous vehicle uploaded by the autonomous vehicle in real time during driving process.
